(19) United States
(12) Patent Application Publication
(10) Pub. No.: US 2022/0021011 A1
(43) Pub. Date: Jan. 20, 2022

(54) TURBO-BLOWER HAVING COMPLEX COOLING STRUCTURE FOR FUEL CELL

(71) Applicant: TURBOWIN CO., LTD., Cheongju-si, Chungcheongbuk-do (KR)

(72) Inventor: Minsoo KIM, Daejeon (KR)

(73) Assignee: TURBOWIN CO., LTD., Cheongju-si, Chungcheongbuk-do (KR)

(21) Appl. No.: 17/290,252

(22) PCT Filed: Oct. 28, 2019
(86) PCT No.: PCT/KR2019/014310

§ 371 Date: Apr. 29, 2021

(30) Foreign Application Priority Data
Oct. 30, 2018 (KR) 10-2018-0130828

(51) Int. Cl. H01M 8/04007; H01M 8/04029; H02K 9/06; F04D 25/06

(52) U.S. Cl. CPC H01M 8/04074; H01M 8/04029; F04D 25/082; F04D 25/0613; H02K 9/06

(57) ABSTRACT

The present invention relates to a turbo-blower having a complex cooling structure for a fuel cell, and more specifically, to a turbo-blower having a complex cooling structure for a fuel cell, the turbo-blower providing improved efficiency and durability of an impeller means by inhibiting a temperature rise through cooling of the impeller means that generates high-pressure air, by a cooling structure configured to simultaneously utilize both an air-cooling method and a water-cooling method.

### TECHNICAL FIELD

The present invention relates to a turbo-blower having a complex cooling structure for a fuel cell, and more specifically, to a turbo-blower having a complex cooling structure for a fuel cell, the turbo-blower providing improved efficiency and durability of an impeller means by inhibiting a temperature rise through cooling of the impeller means that generates high-pressure air, by a cooling structure configured to simultaneously utilize both an air-cooling method and a water-cooling method.

### BACKGROUND ART

Due to problems such as the steady rise in oil price according to the depletion of fossil energy and the environmental pollution according to the exhaust gas emitted from vehicles, the development of vehicles using a fuel cell is being even more desperately needed.

The fuel cell is a cell capable of generating electrical energy in the course of the reaction of hydrogen and oxygen. Accordingly, a fuel cell vehicle includes a fuel cell stack, a hydrogen supplier for supplying the hydrogen to the fuel cell stack, and an air blower etc. for supplying the compressed air to the fuel cell stack.

Particularly, in case of the air blower for fuel cell, it requires a low flow rate and a high pressure. Also, it requires a high durability and a low noise, and a broad driving range.

Such an air blower for fuel cell is a device for supplying an oxygen required to generate electricity in the fuel cell stack and a key component of the fuel cell system. Also, it includes the process of compressing the atmosphere so as to reduce the passage resistance generated in the process of being passed to the fuel cell stack.

Also, the kinds of the air blowers for fuel cell are determined by levels of air pressure and flow rate required in the fuel cell stack. For example, in the area of low pressure and high flow rate, screw or displacement type compressor is applied. In the area of relatively high flow rate and low pressure, a turbo type compressor is applied in general.

In the case of the screw compressor, it is operated at a rpm lower than that of the turbo type compressor and have an intuitively understandable compression structure. However, it has heavy and bulky shortcomings. In the case of the turbo type compressor, it has inexpensive but small and simple structure. However, it is necessary to secure the lubrication structure appropriate for high speed rotation.

In the present invention, it concentrates upon the experiments on the cooling method and cooling structure of the conventional the fuel cell air blower for vehicle. Accordingly, it is to provide the air blower for fuel cell capable of improving efficiency and durability by trapping the heat of the air blower for fuel cell.

As the prior art related to a turbo-blower having a complex cooling structure for a fuel cell, “an air blower for a fuel cell vehicle” of Korea Patent registration No. 10-1735042 (hereinafter referred to as “Patent Literature 1”) is disclosed.

Patent Literature 1 relates to an air blower for a fuel cell vehicle having an air flowing groove formed at an area contacting an outer peripheral portion of a bearing thereby making it possible to improve durability by reducing a shaft load and a cooling water passage formed in a motor case, thereby making it possible to further increase cooling efficiency.

As further prior art, “an air blower for a fuel cell vehicle” of Korea Patent publication No. 10-2016-0097884 (hereinafter referred to as “Patent Literature 2”) is disclosed.

Patent Literature 2 relates to an air blower for a fuel cell vehicle, including a housing, an impeller support part, an impeller housing, a rear cover, and a blower motor. The housing forms the exterior of the air blower. The impeller support part is coupled to the front side of the housing and supports an impeller inducing outer air. The impeller housing is coupled to the impeller support part to cover the impeller and has an air inlet inducing air and an air outlet discharging compressed air. The rear cover is coupled to the rear side of the housing. The blower motor is installed on the interior of the housing and drives the rotation of the impeller. The impeller support part can include a first flow path allowing the air induced by the impeller to be introduced into the housing. According to the present invention, since the air blower has no separate drainage hose and no port for drainage, the air blower can be easily managed, and there is no need to replace a drainage hose. Moreover, a rotor of the blower motor is able to be sufficiently cooled to reduce deterioration of durability of a bearing and lift-shortening due to heat of the rotor.

As described above, the Patent Literatures 1 and 2 are the same technical field as the present invention and are partially identical with the present invention in terms of the subject matters to be solved by the invention (object of the invention). However, there are differences in the resolving means that is, components and the effects thereof between them.

Thus, the technical features thereof are different from each other.

### PATENT LITERATURE

Patent Literature 1: Korean Patent Registration No. 10-1735042 (May 4, 2017)
Patent Literature 2: Korean Patent publication No. 10-2016-0097884 (Aug. 18, 2016)

### DISCLOSURE

### Technical Problem

In this respect, the present invention is made to solve such problems of the related art described above, and an object thereof is to provide a turbo-blower for a fuel cell, the turbo-blower providing improved efficiency and durability by decreasing a temperature rise of an impeller means by forming a cooling structure configured to simultaneously utilize both an air-cooling method and a water-cooling method.

Another object thereof is to provide a turbo-blower for a fuel cell in which a temperature rise is decreased, particularly by using air suctioned without an external force into a blower casing means by an impeller means.

Still another object of the present invention is to provide a turbo-blower for a fuel cell which exhibits consistent performance by securing an amount of air suctioned into a blower casing means by an impeller means.

### Technical Solution

According to one aspect of the present invention so as to accomplish these objects, there is provided to a turbo-blower having a complex cooling structure for a fuel cell is configured to include: a blower casing means that guides flow and discharge of suctioned air; and an impeller means that is positioned inside the blower casing means and is coupled to the blower casing means and generates inflow and flow of air, and the blower casing means is configured to include: an impeller means air-cooling portion that cools the impeller means by using flow of air suctioned inside the blower casing means by the impeller means; and an impeller means water-cooling unit that is formed to neighbor the impeller means and cools the impeller means by using flow of cooling water supplied from outside such that a decrease in temperature rise, efficiency, and durability of the impeller means rotating at a high speed are maximized.

In the meantime, it should be understood that the terminology or the words used in claims should not be interpreted in normally or lexically sense. It should be interpreted as meaning and concept consistent with the technical idea of the present invention, based on the principle that the inventor can properly define the concept of the term in order to describe its invention in the best way.

Therefore, the embodiments described in the present specification and the configurations shown in the drawings are only the most preferred embodiments of the present invention, and not all the technical ideas of the present invention are described. Therefore, it is to be understood that various equivalents and modifications are possible.

### Advantageous Effects

As described above in the configurations and operations, according to the present invention, an impeller means generating compressed air is cooled by a cooling structure configured to simultaneously utilize both an air-cooling method and a water-cooling method.

In particular, a cooling method of utilizing air-cooling is carried out by using flow of air suctioned without an external force into a blower casing means by an impeller means. The flow of air decreases a temperature rise, and air used for cooling the impeller means is not emitted outside but is induced as it is to flow into an impeller, and thereby efficiency of the impeller means is increased.

That is, since the impeller means fulfills not only a function of compressing air but also a function of a cooling fan which suctions air which is used to cool the impeller means, a separate energy source provided to operate a cooling fan is omitted, and flow of suctioned air decreases the temperature of the impeller means. Further, the air is compressed to be discharged to a fuel cell stack, and thereby efficiency of the impeller means is maximized.

As a result, efficiency and durability of the turbo-blower for a fuel cell is improved.

In addition, a sufficient amount of air suctioned into the blower casing means is secured through a suctioned air securing portion such that an amount of air which is compressed by the impeller means to be supplied to the fuel cell stack is to be constantly maintained.

That is, the present invention is a very effective invention in that the turbo-blower for a fuel cell is completely cooled such that high efficiency and cost saving are maintained and secured.

### BRIEF DESCRIPTION OF DRAWINGS

The above and other objects, features and advantages of the present invention will be more apparent from the following detailed description taken in conjunction with the accompanying drawings, in which:

FIG. 1 illustrates a configurational diagram of the turbo-blower having a complex cooling structure for a fuel cell as the present invention;

FIG. 2 illustrates a perspective view of a state of the turbo-blower having a complex cooling structure for a fuel cell as the present invention;

FIG. 3 illustrates a cross sectional view of the turbo-blower having a complex cooling structure for a fuel cell as the present invention; and

FIG. 4 is a flow chart briefly illustrating an operation and a flow of air of the turbo-blower having a complex cooling structure for a fuel cell as the present invention.

### REFERENCE SIGNS LIST

1: a turbo-blower having a complex cooling structure for a fuel cell
100: blower casing means
110: air suction duct
120: air flow guiding cover
130: air emitting duct
140: suctioned air securing portion
150: impeller means air-cooling portion
160: impeller means water-cooling unit
161: cooling-water inflowing/circulating groove
170: first air flow path
180: second air flow path
190: air circulating chamber
200: impeller means
210: stator
220: rotor
230: impeller
S100: impeller means operating step
S200: air suctioning step
S300: air flowing step
S310: first air flow path generating step
S320: second air flow path generating step
S400: impeller means cooling step
S500: air compressing step
S600: compressed air emitting step
S700: compressed air supplying step

### BEST MODE

### Mode for Invention

Hereinafter, a function, a configuration, and an operation of a turbo-blower having a complex cooling structure for a fuel cell as the present invention will be described in detail with reference to the accompanying drawings.

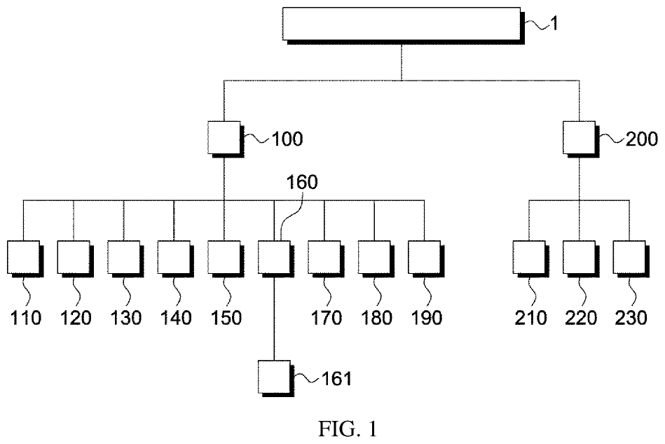

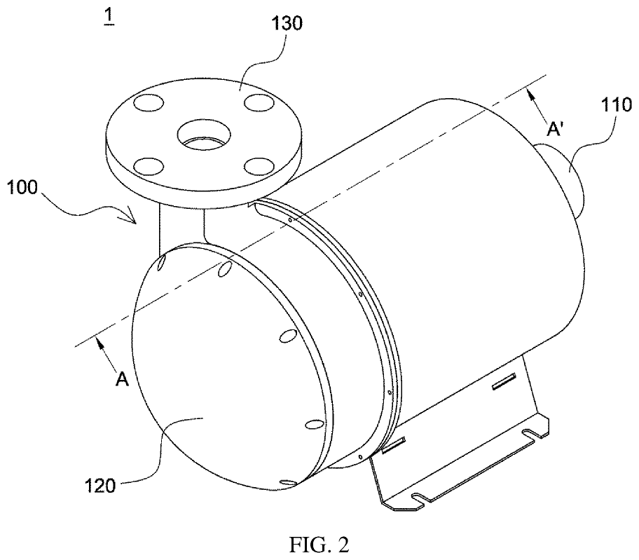

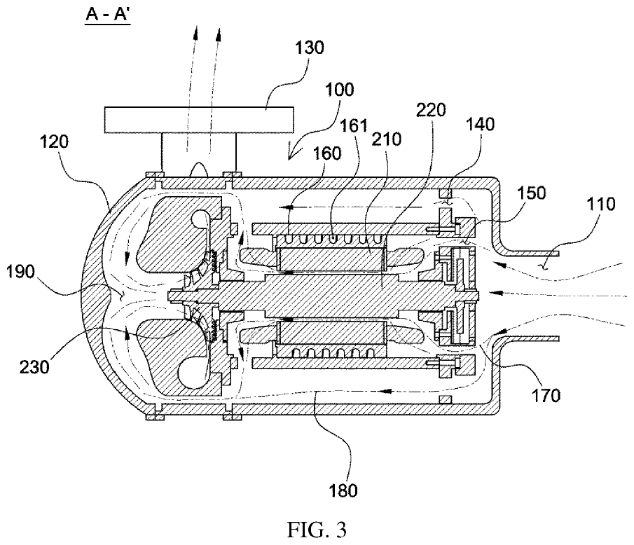

FIG. 1 illustrates a configurational diagram of the turbo-blower having a complex cooling structure for a fuel cell as the present invention. FIG. 2 illustrates a perspective view of a state of the turbo-blower having a complex cooling structure for a fuel cell as the present invention. FIG. 3 illustrates a cross sectional view of the turbo-blower having a complex cooling structure for a fuel cell as the present invention.

As illustrated in FIGS. 1 to 3, according to the present invention, a turbo-blower (1) having a complex cooling structure for a fuel cell is configured to include:

a blower casing means (100) that guides flow and discharge of suctioned air; and

an impeller means (200) that is positioned inside the blower casing means (100) and is coupled to the blower casing means (100) and generates inflow and flow of air, and

the blower casing means (100) is configured to include: an impeller means air-cooling portion (150) that cools the impeller means (200) by using flow of air suctioned inside the blower casing means (100) by the impeller means (200); and an impeller means water-cooling unit (160) that is formed to neighbor the impeller means (200) and cools the impeller means (200) by using flow of cooling water supplied from outside such that a decrease in temperature rise, efficiency, and durability of the impeller means (200) rotating at a high speed are maximized.

That is, the present invention provides a turbo-blower for a fuel cell which enables oxygen to be supplied to a fuel cell stack, for solving a problem (short service life or a decrease in efficiency) of the turbo-blower for a fuel cell due to high heat, by maximizing a cooling effect of the turbo-blower for a fuel cell and improving efficiency and durability of the turbo-blower for a fuel cell through cooling an impeller means (200), which generates compressed air, by a cooling method of utilizing both air-cooling and water-cooling simultaneously.

More specifically, the blower casing means (100) that guides air suctioned inside by the impeller means (200) to a specific path to inhibit a temperature rise of the impeller means (200) is configured to include, as illustrated in FIG. 3,

an air suction duct (110) that allows air to be suctioned inside;

an air flow guiding cover (120) that is formed to have a curved surface, is air-tightly coupled to the impeller means (200) at a neighboring position, and guides air suctioned inside to the impeller means (200);

an air emitting duct (130) that causes air subjected to a pressure rise through the impeller means (200) to be discharged to a fuel cell stack;

a suctioned air securing portion (140) that causes an amount of air suctioned inside the blower casing means (100) to be secured;

an impeller means air-cooling portion (150) that cools the impeller means (200) by using flow of air suctioned inside the blower casing means (100) by the impeller means (200);

an impeller means water-cooling unit (160) that is formed to neighbor the impeller means (200), cools the impeller means (200) by using flow of cooling water supplied from outside, and has a cooling-water inflowing/circulating groove (161);

a first air flow path (170) that is generated by the air suction duct (110), the impeller means air-cooling portion (150), and the air flow guiding cover (120);

a second air flow path (180) that is generated by the air suction duct (110), the suctioned air securing portion (140), and the air flow guiding cover (120); and

an air circulating chamber (190) that is formed by the air flow guiding cover (120) and causes air suctioned through the first air flow path (170) and the second air flow path (180) to easily flow.

The turbo-blower for a fuel cell is configured to maximize efficiency and durability by decreasing a temperature rise of the impeller means (200) rotating at a high speed and guiding the air suctioned inside the blower casing means (100) to a specific path as described above.

That is, as described above, the efficiency and durability of the turbo-blower for a fuel cell are improved by inhibiting a temperature rise inside the blower casing means (100) by the cooling method of utilizing both air-cooling and water-cooling simultaneously and further promoting a thermal equilibrium state in the turbo-blower for a fuel cell.

An organic coupling relationship of the blower casing means (100) of the present invention together with coupling to the impeller means (200) maximizes an effect that the turbo-blower for a fuel cell can exhibit.

For example, firstly, forming of the impeller means air-cooling portion (150) allows air suctioned into the air suction duct (110) by the impeller means (200) to come into contact with the impeller means (200) and the impeller means water-cooling unit (160) and inhibits a temperature rise of the impeller means (200) and the impeller means water-cooling unit (160).

That is, suctioned air is divided into two streams (first air flow path (170) and second air flow path (180)) by the impeller means air-cooling portion (150) and the suctioned air securing portion (140) and cools the impeller means (200) through the first air flow path (170) and the impeller means water-cooling unit (160) through the second air flow path (180) to inhibit a temperature rise.

Secondly, the impeller means water-cooling unit (160) formed to neighbor the impeller means (200) inhibits a temperature rise of the impeller means (200), together with the impeller means air-cooling portion (150).

That is, the impeller means air-cooling portion (150) cools a stator (210) and a rotor (220) of the impeller means (200) by using suctioned air, and the impeller means water-cooling unit (160) cools the stator (210) of the impeller means (200) by using cooling water.

Air suctioned into the second air flow path (180) through the air suction duct (110) and the suctioned air securing portion (140) cools inner walls of the impeller means water-cooling unit (160) and the blower casing means (100) and inhibits a temperature rise of the impeller means (200) and the impeller means water-cooling unit (160).

Thirdly, the air flow guiding cover (120) that is formed to have a curved surface which appears to surround an impeller (230) is air-tightly coupled to the impeller means (200) at a neighboring position of the impeller (230) of the impeller means (200) coupled to the air suction duct (110) in an opposite direction such that the impeller means air-cooling portion (150) and the impeller means water-cooling unit (160) are smoothly operated. In this manner, noise is reduced, and air is to be suctioned only through the air suction duct (110).

In addition, the air flow guiding cover (120) is a configurational element used to generate the first air flow path (170) and the second air flow path (180) and guides air suctioned through the first air flow path (170) and the second air flow path (180) to easily flow into the impeller (230).

Fourthly, in order to overcome a problem of a lack of an amount of air which has to flow into the impeller (230) due to a positional relationship between the impeller (230) of the impeller means (200) and the air suction duct (110) of the blower casing means (100), a sufficient amount of air which flows into the impeller 230 is to be secured by generating a second air flow path (170) through the suctioned air securing portion (140).

In another words, positions, at which the impeller (230) and the air suction duct (110) are formed, are both edges of the blower casing means (100), and thus the suctioned air securing portion (140) for smooth flowing of the suctioned air and for securing of the amount of air is formed.

That is, the present invention focuses on a cooling method of the impeller means (200) as a part of maximizing efficiency and durability of the turbo-blower for a fuel cell such that a cooling structure that can utilize both air-cooling and water-cooling simultaneously by organic coupling of the blower casing means (100) and the impeller means (200) together to cool the impeller means (200).

Further, in the turbo-blower (1) having a complex cooling structure for a fuel cell as the present invention, air suctioned through the air suction duct (110) absorbs heat from the impeller means (200) to cool the impeller means (200) while passing through the impeller means (200), and active molecular motion of air is promoted due to the absorbed heat, and thereby air is to easily flow toward the impeller (230).

That is, the present invention inhibits the temperature rise of the impeller means (200), decreases noise, and maximizes efficiency and durability of the turbo-blower for a fuel cell.

Meanwhile, the impeller means (200) that suctions air inside the blower casing means (100) is configured to include:

the stator (210);

the rotor (220); and

the impeller (230), so as to have the same configuration as a high-speed motor formed in a turbo-blower for a fuel cell in the related art.

The present invention is a technology for cooling the impeller means (200) through the organic coupling of the blower casing means (100) and the impeller means (200), and, particularly, organic coupling of the blower casing means (100) to which the impeller means (200) is coupled, and the present invention is not a technology related to the impeller means (200), and thus the detailed description of the technology related to the impeller means (200) is to be omitted.

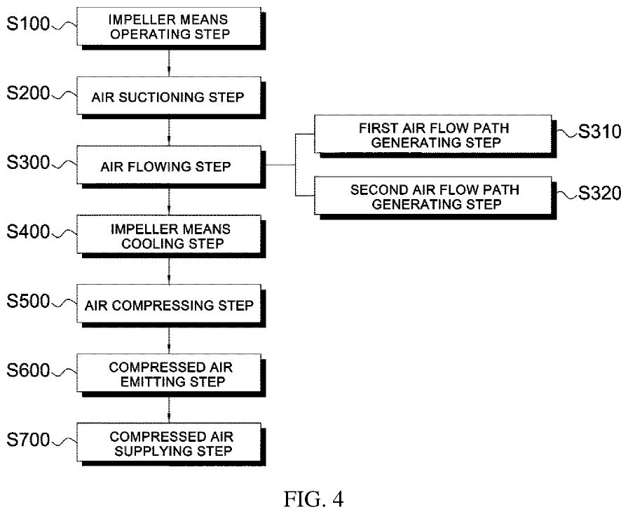

Meanwhile, to briefly describe the operation and the flow of air of the turbo-blower (1) having a complex cooling structure for a fuel cell with reference to FIG. 4, the impeller means (200) rotates by energy supplied from outside ( [symbol] S100, impeller means operating step), and the impeller means (200) rotating at a high speed causes air to be suctioned inside the blower casing means (100) ( [symbol] S200, air suctioning step).

Air suctioned inside the blower casing means (100) flows by being divided into two streams ( [symbol] S300, air flowing step), divided air flows along the first air flow path (170) and the second air flow path (180) ( [symbol] S310 and S320, first air flow path generating step and second air flow path generating step), and the impeller means (200) is cooled ( [symbol] S400, impeller means cooling step).

The air flowing along each of the first air flow path (170) and the second air flow path (180) is compressed by the impeller (230) ( [symbol] S500, air compressing step), the compressed air is discharged by the air emitting duct (130) ( [symbol] S600 compressed air emitting step), and the compressed air is supplied to the fuel cell stack coupled to the air emitting duct (130) ( [symbol] S700, compressed air supplying step)

Here, the impeller means water-cooling unit (160) continuously performs cooling of the impeller means (200) by utilizing water-cooling in a process from the impeller means operating step (S100) to the compressed air supplying step (S700) such that the impeller means (200) is cooled.

That is, the present invention relates to the turbo-blower for a fuel cell which compresses suctioned air and transfers compressed air to the fuel cell stack.

As described above, the present invention is not limited to the described embodiment, and it is obvious for those who have common knowledge in the art to variously modify and change the present invention without departing from the idea and the scope of the present invention.

Hence, since the present invention can be realized as various embodiments without departing from the technical idea or the major feature, the embodiments of the present invention are only provided as simple examples and are not to be construed narrowly but can be variously modified.

### INDUSTRIAL APPLICABILITY

The present invention relates to a turbo-blower having a complex cooling structure for a fuel cell, it can be applied to a manufacturing business of manufacturing turbo-blowers and a sales business thereof, particularly, to an industry related to a turbo-blower for a fuel cell for supplying compressed air to a fuel cell stack, and further, it can contribute to an improvement in various industrial fields of general industries or the like in which compressed air is used.

1. A turbo-blower (1) having a complex cooling structure for a fuel cell, for solving a problem (short service life or a decrease in efficiency) of the turbo-blower for a fuel cell due to high heat, by maximizing a cooling effect of the turbo-blower for a fuel cell and improving efficiency and durability of the turbo-blower for a fuel cell, through cooling an impeller means (200), which generates compressed air, by a cooling method of utilizing both air-cooling and water-cooling simultaneously, the turbo-blower comprising:
a blower casing means (100) that guides flow and discharge of suctioned air; and
an impeller means (200) that is positioned inside the blower casing means (100) and is coupled to the blower casing means (100) and generates inflow and flow of air,
wherein the blower casing means (100) that guides air suctioned inside to a specific path to inhibit a temperature rise of the impeller means (200) is configured to include:
an air suction duct (110) that allows air to be suctioned inside;
an air flow guiding cover (120) that is formed to have a curved surface, is air-tightly coupled to the impeller means (200) at a neighboring position, and guides air suctioned inside to the impeller means (200);
an air emitting duct (130) that causes air subjected to a pressure rise through the impeller means (200) to be discharged to a fuel cell stack;
a suctioned air securing portion (140) that causes an amount of air suctioned inside the blower casing means (100) to be secured;
an impeller means air-cooling portion (150) that cools the impeller means (200) by using flow of air suctioned inside the blower casing means (100) by the impeller means (200);
an impeller means water-cooling unit (160) that is formed to neighbor the impeller means (200), cools the impeller means (200) by using flow of cooling water supplied from outside, and has a cooling-water inflowing/circulating groove (161);
a first air flow path (170) that is generated by the air suction duct (110), the impeller means air-cooling portion (150), and the air flow guiding cover (120);
a second air flow path (180) that is generated by the air suction duct (110), the suctioned air securing portion (140), and the air flow guiding cover (120); and
an air circulating chamber (190) that is formed by the air flow guiding cover (120) and causes air suctioned through the first air flow path (170) and the second air flow path (180) to easily flow,
wherein the turbo-blower for a fuel cell is configured to maximize efficiency and durability by decreasing a temperature rise of the impeller means (200) rotating at a high speed and guiding the air suctioned inside the blower casing means (100) to a specific path as described above,
wherein the impeller means (200) that causes air to be suctioned inside the blower casing means (100) is configured to include:
a stator (210);
a rotor (220); and
an impeller (230),
wherein suctioned air is compressed, and compressed air is delivered to the fuel cell stack, and
wherein a decrease in temperature rise, efficiency, and durability of the impeller means (200) rotating at a high speed are maximized by inhibiting a temperature rise inside the blower casing means (100) by the cooling method of utilizing both air-cooling and water-cooling simultaneously and further promoting a thermal equilibrium state.
